(19) United States
(12) Patent Application Publication
(10) Pub. No.: US 2025/0014320 A1
(43) Pub. Date: Jan. 9, 2025

(54) EMOTIONAL ENGAGEMENT DETECTION METHOD BASED ON POSITIVE EMOTIONAL PERCEPTION

(71) Applicant: Jiangxi Normal University, Nanchang (CN)

(72) Inventors: Zhenzhen Luo, Nanchang (CN); Yong Luo, Nanchang (CN); Le Qin, Nanchang (CN); Xiaolin Gui, Nanchang (CN)

(21) Appl. No.: 18/747,370

(22) Filed: Jun. 18, 2024

(30) Foreign Application Priority Data
Jul. 4, 2023 (CN) 202310811417.5

(51) Int. Cl. G06V 10/80; G06Q 50/20; G06T 7/70; G06V 40/16

(52) U.S. Cl. CPC G06V 10/811; G06Q 50/20; G06T 7/70; G06V 40/176; G06T 2207/20081; G06T 2207/30201

(57) ABSTRACT

An emotional engagement detection method based on positive emotional perception is provided, which relates to a field of data analysis technologies. The emotional engagement detection method is to extract features from data of different dimensions during student classroom learning, to achieve information recognition of each dimension, and perform decision fusion and result analysis and application. The emotional engagement detection method is to extract the features from the data of different dimensions during the student classroom learning, applies a fusion strategy based on a deep learning network for subsequent supervision classification, to construct a positive emotional engagement model of a student. Different modalities information such as cognition, emotion and thinking of the student obtained from different means is integrated to a frame, to comprehensively reflect a positive emotion of the student.

### TECHNICAL FIELD

The disclosure relates to the field of data analysis technologies, and more particularly to an emotional engagement detection method based on positive emotional perception.

### BACKGROUND

Emotional engagement is an important quantitative indicator for a process evaluation of student learning, an emotional intention of a student can be discovered and a learning potential of the student can be tapped through tracking and evaluating an emotional state of the student in a whole process of learning. As a special emotion, a positive emotion play an important role in human learning. A study discovers that learning efficiency and cognitive ability are improved, learning interest of the student is stimulated, and teacher-student relationship is harmonized under a positive emotional experience of the student. The positive emotion can promote individual development potential and virtue, enhance individual positive emotional experience, broaden cognitive scope, and improve cognitive flexibility. Therefore, it is significant to pay attention to a positive emotional change of the student in a learning process, enhance the positive emotional experience of the student in the learning process, and promote the learning interest of the student in the learning process.

At present, a study on detection and analysis of the positive emotion of the student in a classroom teaching environment is in its infancy, a method of combining theory with practice is a necessary mean to explore this field. On the one hand, a current study on intelligence of the positive emotion of the student focuses on identifying and analyzing a facial emotion or a body pose of the student, without comprehensively considering a cognitive activity and a thinking expansion activity in a process of the positive emotion of the student, which cannot fully reflect a positive emotional state of the student. On the other hand, in a classroom teaching scenario, a number of students is larger and behaviors of the students are complex, and there are still many technical difficulties in effectively analyzing an emotional state of the student under the positive emotion through existing computer vision and pattern recognition technologies. Therefore, it is urgent to construct a theoretical model that can describe the positive emotion of the student in a teaching environment from multi-dimension.

Improving the positive emotion of the student in the classroom and stimulating vitality of the student is a widely concerned issue among educational researchers. With an accelerated fusion, innovation, and development of technologies such as artificial intelligence, big data, mobile communication, virtual reality, and internet of things with other technologies, a learning behavior, a body language, a learning emotional state, and other classroom process situational information of the student can be captured by an intelligent monitoring device, a learning device, a mobile device, and an environmental perception device. Therefore, it is possible to assist a teacher in timely understanding a positive emotional change of the student in the classroom through the intelligent devices such as computers.

At present, a recognition of the positive emotional state of the student is mainly based on a physiological information recognition, an image and video recognition, and a speech feature recognition. Although the above different methods can to some extent achieve the detection of the positive emotional state of the student, these methods still have the following disadvantages.

### (1) A Non-Invasive and Natural Detection Method in the Classroom Teaching Scenario is Lacked.

A method based on human physiological signal analysis is to extract the physiological signal of the student through wearable devices such as a smart bracelet and a smart helmet, extract information related to the emotion of the student through signal processing and feature analysis, and realize a monitoring of the emotional state of the student. Although the above methods can predict the emotional state of the student to some extent, the methods require the student to wear or carry an invasive signal collection device, which is not conducive to a natural interaction of the student, and is not suitable for the emotional detection of a large number of students in the classroom teaching scenario.

A method based on the speech feature recognition is to extract acoustic features that can express the emotion from a speech signal and find out a mapping relationship between the acoustic features and human emotion. The emotional state of a speaker can be estimated by the speech feature recognition. However, due to a technical limitation, the speech feature recognition rate is generally low at present. Secondly, due to a shortcoming of a speech emotion database itself and an insufficient accuracy of a labeling result, and a generalization performance of a speech model is insufficient. Therefore, the speech feature recognition method do not have good scalability.

### (2) 6 Basic Emotions of a Psychologist are not Applicable to the Classroom Teaching.

A method based on the image and video analysis tends to identify the 6 basic emotions, and the 6 basic emotions are respectively happiness, sadness, surprise, fear, anger and disgust, which lack the recognition of the positive emotions. The traditional 6 basic emotions do not often appear in the classroom, or even hardly appear, thus the 6 basic emotions are not suitable for the classroom teaching. The method based on the image and video analysis does not take into account an intensity of an emotional experience of the student, that is, different students have varying degrees of emotional response under a same positive emotional experience.

### (3) The Positive Emotion Cannot be Estimated Solely Through General Emotion Recognition.

Different from the general emotions, the positive emotions refer to an active emotion or an emotion with positive valence. In an information-based classroom with active involvement of the student and positive emotion guidance, besides listening, depression and confusion, cognitive involvement and thinking expansion of the student guided by the positive emotion are more positive, thus the positive emotion is essentially different from the general emotion recognition, and the positive emotion cannot be estimated solely by the emotion recognition.

### (4) A Single Dimension of Emotional Engagement Level Detection is One-Sided.

The positive emotion, as an active emotion, is a pleasant emotion produced by events satisfying individual needs, and the positive emotion includes: happiness, interest, satisfaction, love and other basic emotions. However, in a theory of expansion-construction of the positive emotion, Fredrickson explicitly states that the positive emotion not only includes enjoyable emotional experiences, but also expand an individual attention and cognitive range. Previous studies have not only discovered that the positive emotion expands a scope of space attention and time attention and increase attention flexibility, but also discovered that individuals show attention bias to positive stimuli under the positive emotions. At the same time, the theory of expansion-construction of the positive emotion holds that the positive emotion can expand a range of individual instantaneous thinking-action. Therefore, only the emotion recognition in a single dimension such as facial expression, body pose, or physiological recognition cannot fully reflect the positive emotion and emotional experience of the student in the learning process.

### SUMMARY

In order to overcome the aforementioned problems that an existing classroom teacher often focus on classroom teaching and guidance, but cannot realize a real-time and accurate grasp of positive emotional experiences of whole students in a classroom, and cannot understand positive emotional engagement of the student. A purpose of the disclosure is to provide an emotional engagement detection method based on positive emotional perception.

In order to achieve the above purpose, the disclosure provides an emotional engagement detection method based on position emotional perception in a classroom, and the emotional engagement detection method includes:
obtaining a head pose direction, a smile intensity and access records of a learning system of a classroom student;
constructing a smile intensity estimation model by introducing an attention mechanism in a fine-grained image recognition to a deep learning network, and inputting the smile intensity of the classroom student into the smile intensity estimation model to obtain an emotional intensity;
constructing a multi-task head pose estimation model by using a feature-and-spatial aligned network (FSANet), and inputting the head pose direction of the classroom student into the multi-task head pose estimation model to obtain a cognitive attention;
screening the access records of the learning system of the classroom student to obtain a thinking activity;
constructing a positive emotional engagement recognition model based on decision fusion of the classroom student according to a positive emotional engagement model by using the cognitive attention, the emotional intensity and the thinking activity;
obtaining classroom video images and terminal system data for teaching resources, inputting the head pose direction and the smile intensity of the classroom student in the classroom video images and the access records of the learning system in the terminal system data for teaching resources, which are considered as information of complementary different modalities, into a deep network, to perform high-level semantic learning on the different modalities and perform feature fusion on the different modalities, to thereby obtain homogeneous fusion expression;
formulating, according to the head pose direction, the smile intensity and the access records of the learning system of the classroom student, different objective functions, and learning the homogeneous fusion expression through the different objective functions to thereby construct a positive emotional engagement recognition model based on multimodal fusion of the classroom student;
constructing a positive emotional engagement recognition model of the classroom student by combining the positive emotional engagement recognition model based on decision fusion of the classroom student and the positive emotional engagement recognition model based on multimodal fusion of the classroom student; and
recognizing the smile intensity, the head pose direction and the cognitive attention by using the positive emotional engagement recognition model of the classroom student to obtain emotional engagement based on positive emotional perception of the classroom student.

In an exemplary embodiment, the emotional engagement detection method further includes: applying the emotional engagement based on positive emotional perception of the classroom student in classroom teaching, to thereby design a lesson plan by a teacher based on the emotional engagement. Specifically, the applying the emotional engagement based on positive emotional perception of the classroom student in classroom teaching, to thereby design a lesson plan by a teacher based on the emotional engagement includes: providing the emotional engagement based on positive emotional perception of the classroom student to a teacher of the classroom student, and thereby, designing a lesson plan by the teacher based on the emotional engagement based on positive emotional perception of the classroom student.

In an exemplary embodiment, the emotional engagement detection method is implemented by an emotional engagement detection system, and the emotional engagement detection system includes a processor and a memory with an emotional engagement detection application stored therein; and the emotional engagement detection application, when executed by the processor, is configured to implement the emotional engagement detection method and is further configured to send, over the Internet, the emotional engagement to a mobile terminal of a teacher of the classroom student. An application installed in the mobile terminal of the teacher is configured to receive the emotional engagement, and display the emotional engagement on the mobile terminal of the teacher, to thereby assist the teacher in designing a lesson plan for the classroom student.

In an embodiment, the smile intensity estimation model is configured to: based on the attention mechanism in the fine-grained image recognition, suppress useless information learned by a convolutional layer of the deep learning network, and enhance learning of features in a key area by the deep learning network; and the key area is an area where facial muscles that produce a smile are located.

In an embodiment, features of the area where the facial muscles that produce the smile are located include: a coordinate change of a mouth corner feature point and a coordinate change of an eye corner feature point during a smile movement.

In an embodiment, the deep learning network corresponding to the smile intensity estimation model includes: a visual geometry group network (VGGNet) and a residual neural network (ResNet). For the VGGNet, a pre-trained weight is loaded, the pre-trained weight is taken as a starting point for learning to compensate for a shortage of smile datasets, and to capture smile detailed information; and for the ResNet, a pre-trained weight is not loaded, an image feature is learned from scratch, and the ResNet is configured to focus on training information of the smile intensity.

In an embodiment, the emotional engagement detection method further includes: introducing a focal loss function into the deep learning network corresponding to the smile intensity estimation model to improve a cross entropy loss function.

In an embodiment, the inputting the head pose direction and the smile intensity of the classroom student in the classroom video images and the access records of the learning system in the terminal system data for teaching resources, which are considered as information of complementary different modalities, into a deep network, to perform high-level semantic learning on the different modalities and perform feature fusion on the different modalities, to thereby obtain homogeneous fusion expression, specifically includes:
performing feature learning through asymmetric dual stream branches, the asymmetric dual stream branches include a first branch and a second branch; the first branch is configured to utilize a deep cascaded autoencoder to perform feature mapping learning based on original data through a network structure to achieve the high-level semantic learning; and the second branch is configured to extract low-level detail information for each of information of the different modalities; and
connecting a generated high-level feature of each of information of the different modalities to a low-level feature of each of information of the different modalities through a skip layer, and generating a shared sparse fusion feature through an attention-guided feature cross fusion module, to correlate features of the different modalities together in a nonlinear manner and focus the features of the different modalities, and thereby obtain the homogeneous fusion expression.

Compared to the related art, beneficial effects of the disclosure are as follows.

1. The disclosure, by using the smile intensity, the head pose estimation, and the recognition of the thinking activity of the student as inputs, can obtain real-time and accurate grasp of a positive emotional experience of the whole student in the classroom, understand the positive emotional engagement of the student, and enrich a study on the positive emotional engagement of the student.

2. The disclosure constructs the positive emotional engagement recognition model for the classroom student through two methods. A first method is to extract features from data of different dimensions in student classroom learning, achieve information recognition for each dimension, and then perform decision fusion and result analysis and application. A second method is to extract the features from the data of different dimensions in the student classroom learning, and then apply a fusion strategy based on the deep learning network for subsequent supervised classification, to construct the positive emotional engagement model of the student. The two methods study and discover a positive emotional mechanism hidden behind classroom data, to thereby achieve correct predictions or judgments about future lesson plan design, emotional tracking, and personalized classroom assistance, improve classroom teaching effectiveness, and enhance the accuracy of predicting classroom engagement.

### BRIEF DESCRIPTION OF DRAWINGS

FIG. 1 illustrates a schematic diagram of a three-dimensional positive emotional engagement model according to an embodiment of the disclosure.

FIG. 2 illustrates a schematic diagram of a key technology according to an embodiment of the disclosure.

FIG. 3 illustrates a schematic diagram of a smile intensity estimation model based on a dual attention mechanism and a dual network according to an embodiment of the disclosure.

FIG. 4 illustrates a schematic diagram of a multi-task head pose estimation model based on heterogeneous dual stream according to an embodiment of the disclosure.

FIG. 5 illustrates a schematic diagram of a multimodal information decision fusion based on a positive emotional engagement model based on decision fusion according to an embodiment of the disclosure.

FIG. 6 illustrates a schematic diagram of a multimodal information fusion based on deep network corresponding to a positive emotional engagement recognition model based on multimodal fusion according to an embodiment of the disclosure.

### DETAILED DESCRIPTION OF EMBODIMENTS

The disclosure is further described in conjunction with drawings and embodiments below.

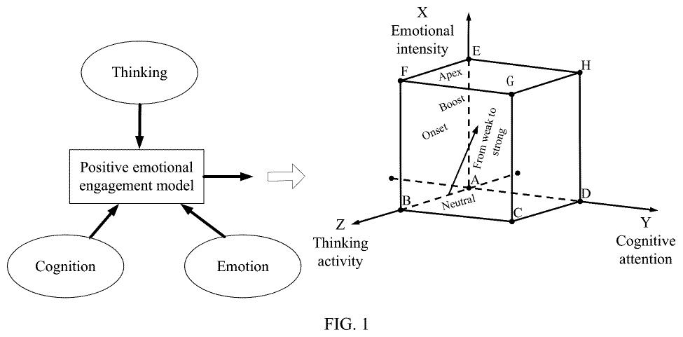

As shown in FIG. 1-5, an intelligent study for positive emotional engagement of an existing student classroom does not comprehensively consider a cognitive activity and a thinking-action activity of a student under a positive emotional state, and cannot fully reflect a problem of the positive emotional engagement of the student. The disclosure provides a three-dimension positive emotional engagement model including cognition, emotion and thinking. As shown in FIG. 1, the cognition reflects an important motivation and a cognitive attention orientation of the student, the emotion reflects a positive emotional experience intensity during learning, and the thinking reflects a thinking-action activity development during learning under a guidance of the positive emotion.

For cognitive attention, existing studies discover that the positive emotion expands scopes of space attention and time attention, and increases attention flexibility, and the existing studies also discover that an individual exhibits an attentional bias towards positive stimuli under the positive emotion. A head pose direction of a student in a classroom can reflect a focus of the student. The studies show that a contribution of a human horizontal head pose in attention direction accounts for 40.3%, a contribution of a human vertical head pose in attention direction accounts for 28.4%, and a contribution of a direction of human eyeball in attention direction accounts for 31.1%. Therefore, the attention bias of the student can be estimated through detecting the head pose direction of the student.

For emotional intensity, the positive emotion can be defined as a feeling when making progress in a process of achieving goals or getting positive comments from others. In the view of a discrete emotion theory, the positive emotion includes happiness, contentment, interest, pride, gratitude and love. A specific facial expression produced by the positive emotion is smile. In all kinds of facial expressions, the smile expression is one of the most widely understood positive expressions. In an interactive recognition experiment of peer-to-peer agent dialogue, Nakamura et al. in the university of Tokyo found that the smile occurs the most frequently of the student under the positive emotional experience. Therefore, the disclosure adopts smile intensity of the student to estimate the emotional experience of the student in the classroom in the positive emotional state.

For the thinking activity, in the embodiment, a terminal system for teaching resources-ChaoXing cloud platform is introduced into classroom teaching, and content of thinking-action activity related to the student is recorded through the cloud platform. An expansion-construction theory of the positive emotion holds that the positive emotion can expand individual instantaneous thinking-action range, and construct individual resources such as intellectual resources (e.g., problem solving skills, new knowledge acquired) and mental resources (e.g., resilience, optimism, identity and goal orientation), so as to bring more benefits to individuals. A large amount of experimental studies indicate that the positive emotion can make an individual thinking patterns unusual, flexible, inclusive, creative, integrated, open, efficient, forward-looking, and high-level. The positive emotion expands an individual tendency to act by increasing an individual tendency to seek diversity and staying open to more behavioral options. Therefore, the thinking activity and the learning activity guided by the positive emotion, as well as exploration, access, clicks, comments, and other information related to student thinking and action, can be recorded on the cloud platform.

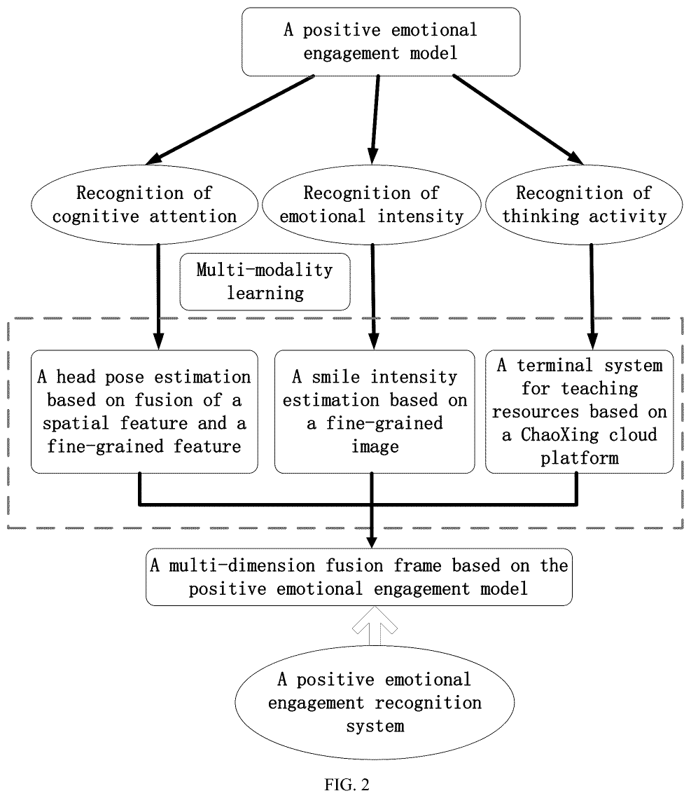

The disclosure is based on technical means of the related art, and extensively refers to a latest research progress at home and abroad, combines with research results in a field of computer vision. Specifically, a fusion process according to information includes three steps: information extraction, information fusion and fusion analysis and application. An overall research scheme of the disclosure is divided into two parts according to an information fusion method. A first part is to extract features from data of different dimensions during student classroom learning, to achieve information recognition of each dimension, to thereby performing decision fusion and result analysis and application. A second part is to extract the features from the data of different dimensions during the student classroom learning, and apply a fusion strategy based on a decp learning network for subsequent supervision classification, to construct a positive emotional engagement model of the student. The two methods study and discover a positive emotional mechanism hidden behind classroom data, to thereby achieve correct predictions or judgments about future lesson plan design, emotional tracking, and personalized classroom assistance, improve classroom teaching effectiveness, and enhance the accuracy of predicting classroom engagement. A specific key technology study is shown in FIG. 2.

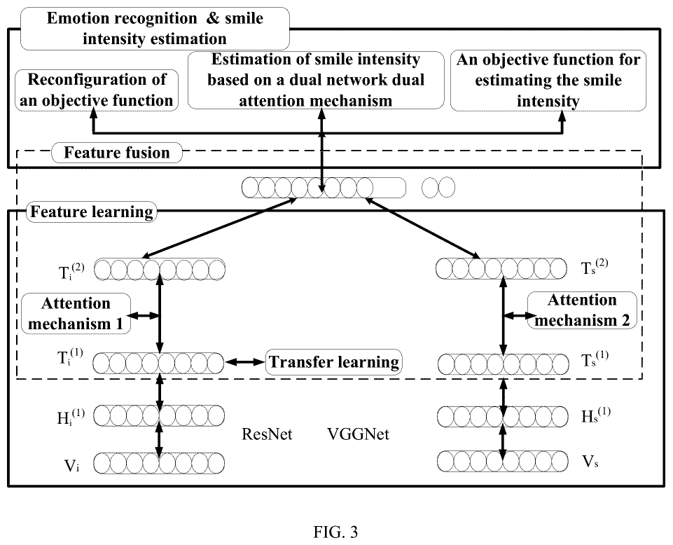

A construction of a smile intensity estimation model based on a dual network dual attention mechanism is provided, as shown in FIG. 3, obtained emotional information is limited though recognizing the smiles, and it is necessary to classify the smiles more finely. Different from the smile recognition, smile intensity samples have a small inter-class gap, and a large recognition difficulty, and the smile intensity does not have a dedicated public dataset.

For the smile intensity estimation task, features of the small inter-class gap and fuzzy subclass boundaries are combined, and an attention mechanism in fine-grained image recognition is introduced, so as to suppress useless information learned by a convolutional layer of the deep learning network, and enhance learning of features in a key area by the deep learning network, especially the learning of features in an area where facial muscles that produce a smile are located, so that a research goal is approached. And the smile intensity estimation task specifically includes the following steps (1)-(4).

In step (1), obvious coordinate changes of a mouth corner feature point and an eye corner feature point during smile movement are discovered in previous research work. Therefore, multiple geometric features are added to guide the deep learning network to learn a favorable feature region, that is to suppress the useless information and enhance the learning of useful information.

In step (2), the deep learning network corresponding to the smile intensity estimation model is used to individually learn features. The deep learning network corresponding to the smile intensity estimation model includes: a visual geometry group network (VGGNet) and a residual neural network (ResNet). For the VGGNet, a pre-trained weight is loaded, the pre-trained weight is taken as a starting point for learning to compensate for a shortage of smile datasets, which is beneficial for suppressing overfitting, and capturing smile detailed information. For the ResNet, a pre-trained weight is not loaded, an image feature is learned from scratch, and the ResNet is configured to focus on training information of the smile intensity. Through fusing the features of the VGGNet and the ResNet, stability of the network model is enhanced, and an extreme tendency of attention learned is avoided, and an influence of a small number of training sets on the model is alleviated by calling a transfer learning weight.

In step (3), different from the smile recognition task, the inter-class gap of different smile samples in the smile intensity estimation model is small, and many indistinguishable samples exist. A number of images with excessive smile intensity in the middle is very small, which is caused by a class imbalance of training samples. Uneven proportion of samples during network training makes it difficult to learn effective feature information from samples with a small proportion, thus introducing a focal loss function to improve a cross entropy loss function.

In step (4), in order to solve problems of insufficient samples and incomplete annotation information in the smile intensity annotation samples, further study a fine-grained image recognition problem for the smile recognition, and solve a smile intensity estimation problem, an annotation based on a relative position of keyframes in video sequences is proposed for facial expression video image sequences in the public datasets by referring an intensity annotation information of an action unit (AU).

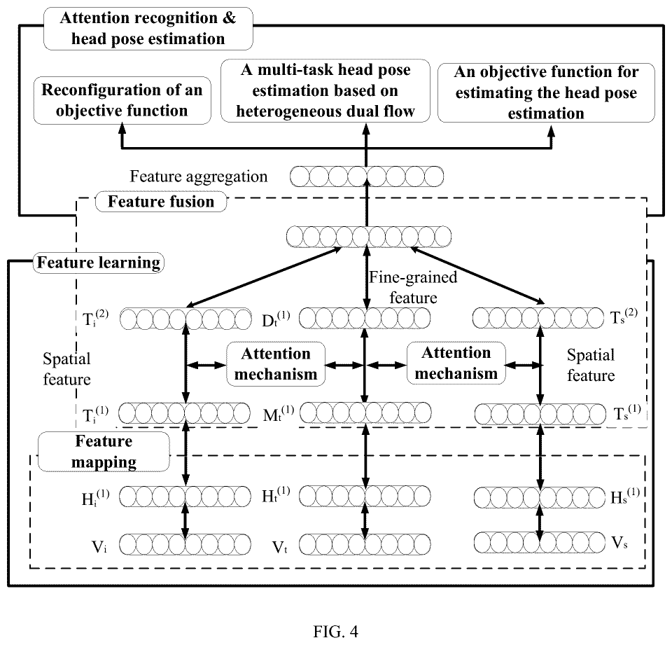

On a basis of feature-and-spatial-aligned network (FSANet), a construction of a multi-task head pose estimation model based on heterogeneous dual stream is proposed, as shown in FIG. 4, the construction specifically includes the following steps (1)-(4).

In step (1), a yaw angle, a pitch angle and a roll angle representing the head pose are separated as three sub tasks, and features of the yaw angle, the pitch angle and the roll angle are individually learned.

In step (2), during extracting features of the head pose, original data of an input head pose dataset is learned through the FSANet structure, to generate different feature mapping, to thereby achieve extraction of spatial features and fine-grained features.

In step (3), its different from the general fined-grained feature extraction is that the attention mechanism in the fine-grained image recognition is introduced to locate features of a key area of the face pose and distribute weights of the features of the key area of the face pose, and guide subsequent fine-grained feature extraction.

In step (4), the features are fused, and further assembled. Different objective functions are formulated, and the homogeneous fusion expression is learned through the different objective functions, so that fusion expression can be further used for subsequent learning task, and a predictive model is construct.

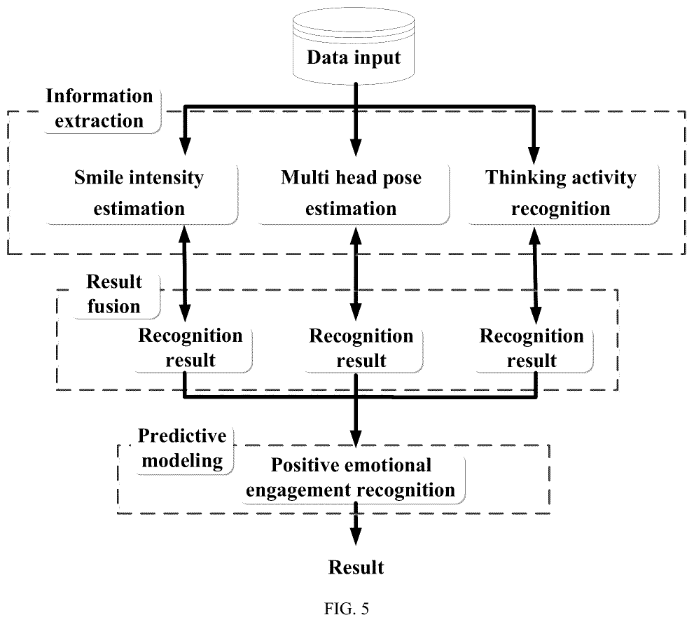

A fusion of a multimodal estimation model is guided based on the positive emotional engagement model. Specifically, the thinking activity of the student is estimated by extracting information related to thinking-action development of the student, such as exploration, clicking and comments of the student on teaching resources through the ChaoXing cloud platform. Classroom learning emotions of the student are extracted through the estimation of the smile intensity. The cognitive attention of the student is obtained through the estimation of the head pose. A schematic diagram of a system model for decision fusion according to results recognized by the above methods and the positive emotional engagement model is shown in FIG. 5.

Unstructured classroom video images and the terminal system data for teaching resources are considered as information of complementary different modalities based on multimodal learning fusion research of the deep network, a more comprehensively description is provided to the positive emotional feature of the student by performing high-level semantic learning on the different modalities and performing feature fusion on the different modalities, and exploring a correlation between multimodal.

An asymmetric hybrid auto-coding deep network model is proposed, and the asymmetric hybrid auto-coding deep network model specifically includes the following steps (1)-(2).

In step (1), asymmetric dual stream branches are used, for each modality, a first branch is configured to utilize a deep cascade autoencoder to perform feature mapping learning based on the original data through the network structure, to achieve high-level semantic learning. A second branch is configured to extract low-level detailed information for each of information of the different modalities.

In step (2), a generated high-level feature of each of information of the different modalities is connected to a low-level feature of each of information of the different modalities through a skip layer, a shared sparse fusion feature is generated through an attention-guided feature cross fusion module, to correlate features of the different modalities together in a nonlinear manner and focus the features of the different modalities, and thereby obtain homogeneous fusion expression, so as to better use enhanced feature representation after fusion, and improve generalization ability of the model.

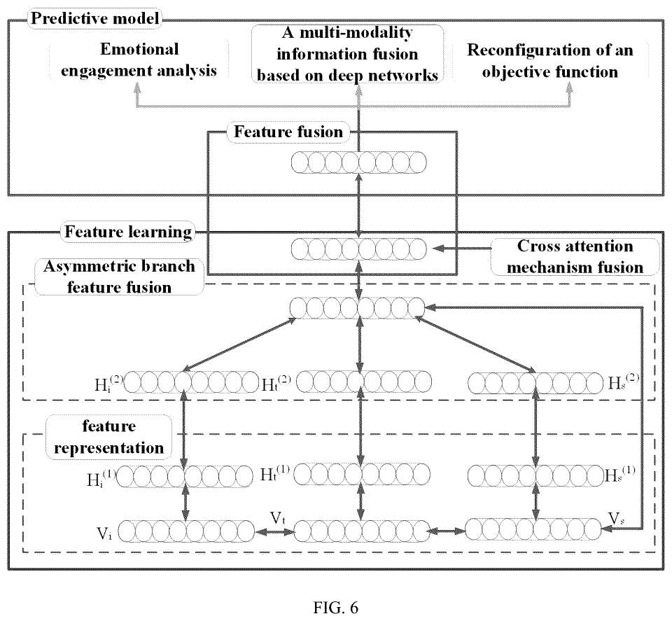

After obtaining the homogeneous fusion expression, different objective functions are formulated for learning the homogeneous fusion expression according to different data analysis problems, thus, the homogeneous fusion expression can be further used for subsequent learning tasks, and the predictive model is constructed, and the predictive model is shown in FIG. 6.

Finally, different objective functions are formulated for learning of the whole network, after effective optimization and solution, positive emotional classification is implemented in an output layer, which provides scientific basis for exploring a potential mechanism of the positive emotion.

It should be noted that in the disclosure, relationship terms such as first and second are only used to distinguish one entity or operation from another entity or operation, without necessarily requiring or implying any such actual relationship or order between these entities or operations. Moreover, terms “including”, “containing”, or any other variation thereof are intended to encompass non-exclusive inclusion, such that a process, method, item, or device that includes a series of elements not only includes those elements, but also includes other elements that are not explicitly listed or inherent to such process, method, item, or device.

The above embodiments are merely examples of the disclosure and do not constitute a limitation on a scope of protection of the disclosure. Any design that is the same or similar to the disclosure falls within the scope of protection of the disclosure.

What is claimed is:

1. An emotional engagement detection method based on positive emotional perception, comprising:
obtaining a head pose direction, a smile intensity and access records of a learning system of a classroom student;
constructing a smile intensity estimation model by introducing an attention mechanism in a fine-grained image recognition to a deep learning network, and inputting the smile intensity of the classroom student into the smile intensity estimation model to obtain an emotional intensity;
constructing a multi-task head pose estimation model by using a feature-and-spatial aligned network (FSANet), and inputting the head pose direction of the classroom student into the multi-task head pose estimation model to obtain a cognitive attention;
screening the access records of the learning system of the classroom student to obtain a thinking activity;
constructing a positive emotional engagement recognition model based on decision fusion of the classroom student according to a positive emotional engagement model by using the cognitive attention, the emotional intensity and the thinking activity;
obtaining classroom video images and terminal system data for teaching resources, inputting the head pose direction and the smile intensity of the classroom student in the classroom video images and the access records of the learning system in the terminal system data for teaching resources, which are considered as information of complementary different modalities, into a deep network, to perform high-level semantic learning on the different modalities and perform feature fusion on the different modalities, to thereby obtain homogeneous fusion expression;
formulating, according to the head pose direction, the smile intensity and the access records of the learning system of the classroom student, different objective functions, and learning the homogeneous fusion expression through the different objective functions to thereby construct a positive emotional engagement recognition model based on multimodal fusion of the classroom student;
constructing a positive emotional engagement recognition model of the classroom student by combining the positive emotional engagement recognition model based on decision fusion of the classroom student and the positive emotional engagement recognition model based on multimodal fusion of the classroom student; and
recognizing the smile intensity, the head pose direction and the cognitive attention by using the positive emotional engagement recognition model of the classroom student to obtain emotional engagement based on positive emotional perception of the classroom student.

2. The emotional engagement detection method based on positive emotional perception as claimed in claim 1, wherein the smile intensity estimation model is configured to: based on the attention mechanism in the fine-grained image recognition, suppress useless information learned by a convolutional layer of the deep learning network, and enhance learning of features in a key area by the deep learning network; and the key area is an area where facial muscles that produce a smile are located.

3. The emotional engagement detection method based on positive emotional perception as claimed in claim 2, wherein features of the area where the facial muscles that produce the smile are located comprise: a coordinate change of a mouth corner feature point and a coordinate change of an eye corner feature point during a smile movement; and
wherein the deep learning network corresponding to the smile intensity estimation model comprises: a visual geometry group network (VGGNet) and a residual neural network (ResNet); for the VGGNet, a pre-trained weight is loaded, the pre-trained weight is taken as a starting point for learning to compensate for a shortage of smile datasets, and to capture smile detailed information; and for the ResNet, a pre-trained weight is not loaded, an image feature is learned from scratch, and the ResNet is configured to focus on training information of the smile intensity.

4. The emotional engagement detection method based on positive emotional perception as claimed in claim 3, further comprising: introducing a focal loss function into the deep learning network corresponding to the smile intensity estimation model to improve a cross entropy loss function.

5. The emotional engagement detection method based on positive emotional perception as claimed in claim 1, wherein the inputting the head pose direction and the smile intensity of the classroom student in the classroom video images and the access records of the learning system in the terminal system data for teaching resources, which are considered as information of complementary different modalities, into a deep network, to perform high-level semantic learning on the different modalities and perform feature fusion on the different modalities, to thereby obtain homogeneous fusion expression, specifically comprises:
performing feature learning through asymmetric dual stream branches, wherein the asymmetric dual stream branches comprise a first branch and a second branch; the first branch is configured to utilize a deep cascaded autoencoder to perform feature mapping learning based on the head pose direction and the smile intensity of the classroom student in the classroom video images and the access records of the learning system through the deep network to achieve the high-level semantic learning; and the second branch is configured to extract low-level detail information for each of information of the different modalities; and
connecting a generated higher-level feature of each of information of the different modalities to a lower-level feature of each of information of the different modalities through a skip layer, and generating a shared sparse fusion feature through an attention-guided feature cross fusion module, to correlate features of the different modalities together in a nonlinear manner and focus the features of the different modalities, and thereby obtain the homogeneous fusion expression.
